(19) United States
(12) Patent Application Publication
(10) Pub. No.: US 2025/0124898 A1
(43) Pub. Date: Apr. 17, 2025

(54) Adjustable Percussion Pad Assembly

(71) Applicant: D'Addario & Company, Inc., Farmingdale, NY (US)

(72) Inventors: Justin Tranchina, Old Bridge, NJ (US); Andrzej J. Krol, Wayne, NJ (US); Zachary Stringham, New York, NY (US); Devin Hasenflue, Commack, NY (US)

(21) Appl. No.: 18/914,661

(22) Filed: Oct. 14, 2024

Related U.S. Application Data
(60) Provisional application No. 63/590,995, filed on Oct. 17, 2023.

(51) Int. Cl. G10D 13/02

(52) U.S. Cl. CPC G10D 13/02

(57) ABSTRACT

A percussion pad assembly has a beatable membrane maintained within a frame. A resilient pad may be included beneath the membrane with a lower plate or other member to trap the pad with the membrane. The tension of the membrane is adjustable by tension rods accessible from underneath, which may act upon a bearing ring positioned within the frame against the membrane. The lower plate is removable to allow access to the resilient pad for removal and/or replacement. The frame may include multiple portions that are separable to allow access to the resilient pad, bearing ring and membrane.

### CROSS-REFERENCE TO RELATED APPLICATION

This application claims priority to U.S. Provisional Application No. 63/590,995, filed on Oct. 17, 2023, for Adjustable Percussion Pad Assembly, the entire contents of which is incorporated by reference.

### BACKGROUND

The disclosed embodiments relate to drums, and, in particular, to a versatile hybrid drum for primary use as a practice pad and optionally as an acoustic drum. The disclosed embodiments are usable as an adjustable practice pad with an authentic feel and reduced volume compared to standard acoustic drums when struck, or as an acoustic drum when optionally fit with a standard drumhead.

Drumming practice pads are known in the art for use by drummers for practicing in settings within which full sound of an acoustic drum is not appropriate, such as nighttime or in close quarters. Many different pads exist today and have many common characteristics. Most, if not all, feature a foam upper pad member affixed permanently to a rigid lower member. Drummers beat the upper pad to practice.

Currently existing drum pads carry drawbacks in that the beatable pad member is not tension adjustable, which only provides a single “feel” when beaten. Additionally, the foam material can become worn down or worn out over time, which provides undesirable sound and/or feel. None of the elements of known practice pads are adjustable, removeable or replaceable. Further, no percussion assemblies exist that are adjustable between a practice pad and an acoustic drum.

Thus, it would be useful to provide a percussion pad assembly that solves one or more of the above noted drawbacks with existing practice pads.

### BRIEF DESCRIPTION OF THE DRAWINGS

FIG. 1 is an exploded view of the disclosed adjustable percussion pad assembly;

FIG. 2 shows the percussion pad assembly in an assembled form;

FIG. 3A shows an embodiment of the top hoop of the percussion pad assembly in isolation;

FIG. 3B shows the top hoop of FIG. 3A with attached connectors;

FIGS. 4A-4C show different views of an embodiment of the bottom hoop of the percussion pad assembly in isolation;

FIG. 5 shows views of an embodiment of the bearing ring of the percussion pad assembly in isolation;

FIG. 6 shows views of an embodiment of the removable plate of the percussion pad assembly in isolation;

FIG. 7 shows an embodiment of a resilient shock absorber that attaches to the removable plate of FIG. 6;

FIG. 8A shows an exemplary tension rod for use within the percussion pad assembly;

FIG. 8B shows an exemplary nut for use within the percussion pad assembly;

FIG. 8C shows an exemplary J-clip style connector for use within the percussion pad assembly; and

FIG. 9 is an enlarged partial section view showing details of the percussion pad assembly as assembled.

### DETAILED DESCRIPTION

Among the benefits and improvements disclosed herein, other objects and advantages of the disclosed embodiments will become apparent from the following wherein like numerals represent like parts throughout the figures. Detailed embodiments of an instrument string with high tensile core wire, that is preferably a covered wound string, are disclosed; however, it is to be understood that the disclosed embodiments are merely illustrative of the invention that may be embodied in various forms. In addition, each of the examples given in connection with the various embodiments of the invention are intended to be illustrative, and not restrictive.

Throughout the specification and claims, the following terms take the meanings explicitly associated herein, unless the context clearly dictates otherwise. The phrase “in some embodiments” as used herein does not necessarily refer to the same embodiment(s), although it may. The phrases “in another embodiment” and “in some other embodiments” as used herein do not necessarily refer to a different embodiment, although it may. Thus, as described below, various embodiments may be readily combined without departing from the scope or spirit of the invention.

As used herein, “based on” is not exclusive and permits being based on additional factors not expressly described unless the applicable context clearly dictates otherwise.

In addition, as used herein, the term “or” is equivalent to the term “and/or,” unless the context clearly dictates otherwise. The term “based on” is not exclusive and allows for being based on additional factors not described unless the context clearly dictates otherwise. In addition, throughout the specification, the meaning of “a,” “an,” and “the” include plural references. The meaning of “in” includes “in” and “on.”

Further, the terms “substantial,” “substantially,” “similar,” “similarly,” “analogous,” “analogously,” “approximate,” “approximately,” and any combination thereof mean that differences between compared features or characteristics is less than 25% of the respective values/magnitudes in which the compared features or characteristics are measured and/or defined.

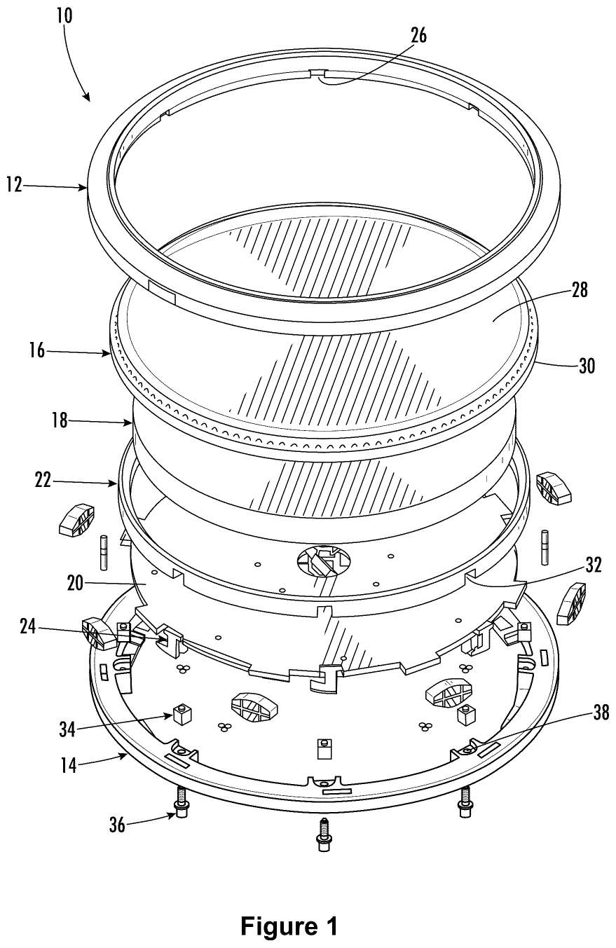

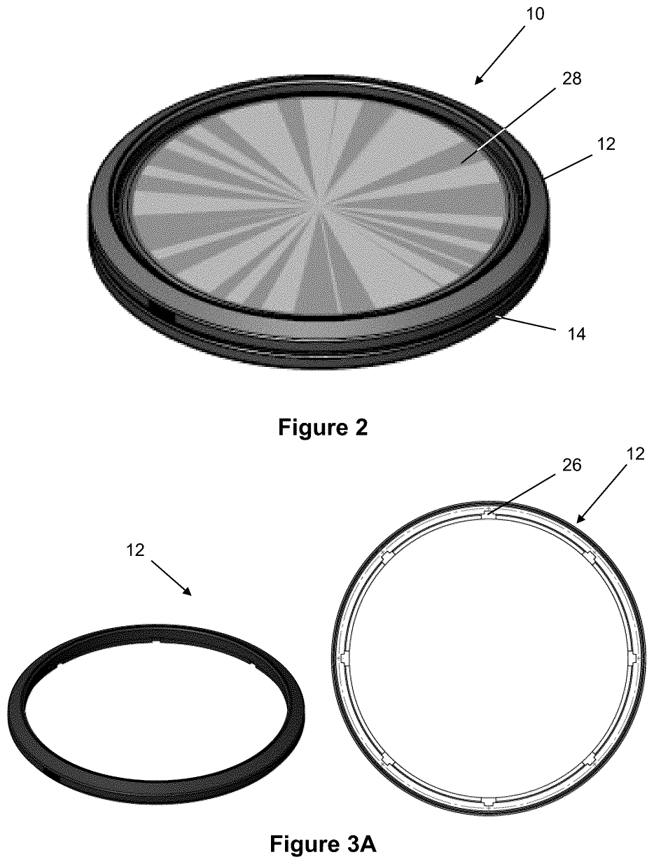

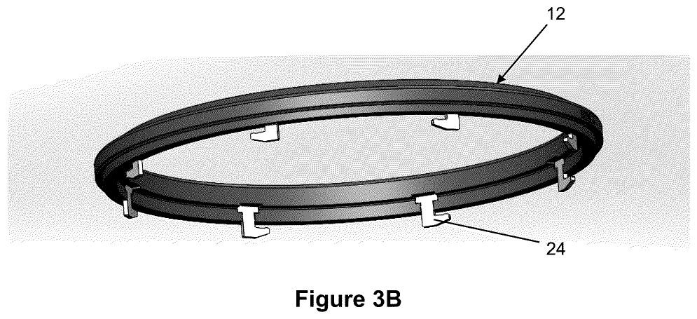

With reference to FIGS. 1-9, disclosed herein is an exemplary embodiment of a percussion pad assembly 10 that is adjustable and within which a central foam pad 18 is easily removable or replaceable with a new pad after the original pad is worn or replaceable with a substrate having different properties, such as firmness or acoustic properties, for example. The percussion pad assembly 10 will be described primarily with reference to a preferred embodiment that forms a practice pad with mesh drumhead. However, it is understood that the percussion pad assembly 10 is ultimately just that—an adjustable percussion pad—and other embodiments exist that form an acoustic or “regular” drum with an acoustic drumhead formed from a polymer film sheet, such as Mylar®, for example.

In the depicted embodiment, the percussion pad assembly 10 generally includes a top hoop 12 and bottom hoop 14 that are attachable to and detachable from one another and are assembled to form an outer frame to hold the other elements together. In this embodiment, a drumhead 16 comprises a mesh membrane 28 defining a top beating surface and which is stretched across a rigid ring 30. In the depicted preferred embodiment, a substantially cylindrical resilient pad 18 is positioned underneath the membrane 28. In a preferred embodiment, the resilient pad 18 is made from a foam material. In this embodiment with resilient pad 18, a removable plate 20 cooperates with the membrane 28 to sandwich the pad 18 and maintain it within the percussion pad assembly 10 when it is assembled. The pad 18 is optionally replaceable with a different pad or material or even removable altogether, as may be desired by a user.

Additionally, a bearing ring 22 sits radially inward of the rigid ring frame 30 of the drumhead 16 and is configured for adjustment to tighten or loosen the membrane 28 (i.e., increase or decrease tension, respectively). Adjustment of the bearing ring 22 is initiated via rotation of multiple threaded bearing tension rods 36 from underneath. Rotating a tension rod 36 causes an associated cooperative nut 34 embedded within the ring 22 to move axially along the threaded section of each rod. In the depicted preferred embodiment, each nut 34 has polygonal prismic shape (typically, but not always, cubic or rectangular prismic), and is received within a notch 32 in the bearing ring 22 and/or molded into the ring. Each nut 34 is received within a notch 32 or molded into the bearing ring 22 such that the nuts cannot rotate with rotation of the corresponding tension rod 36, which thereby causes the nut to move upward or downward along the threading 40 as the rod is rotated. Adjustment of the tension in the drumhead 16 will be described in greater detail below.

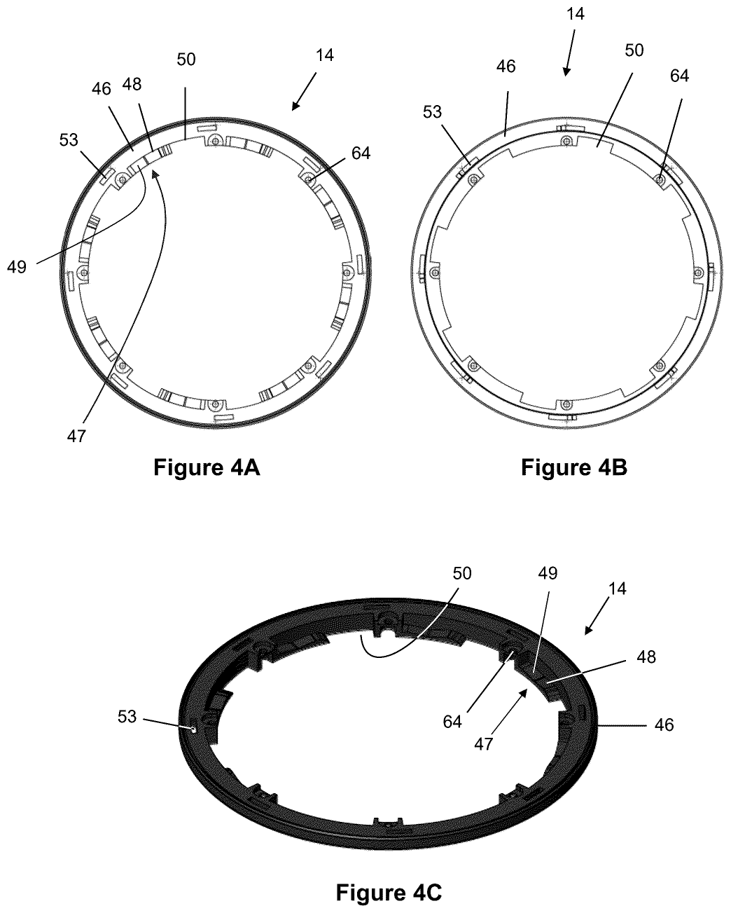

With reference primarily to FIGS. 4A-4C, in this embodiment, the bottom hoop 14 is configured as an annular shaped irregular ring with a peripheral platform 46 and a series of circumferentially spaced apart notches 50 on its radially inward side that are open radially inward. As shown, each of the notches 50 is positioned between an adjacent pair of spaced apart locking ramps 48 with vertical recesses (seen most clearly in FIG. 4A), which are spaced around the inner circumference of the bottom hoop 14. The peripheral platform 46 includes a plurality of slots 53 circumferentially spaced from each other. The bottom hoop 14 also defines a series of passages 64, each configured for receipt of a portion of a tension rod 36. When the percussion pad assembly 10 is assembled as intended, the ramps 48 are on the upper (or inner) side of the bottom hoop 14 with the notches 50 and holes 64 extending from the upper (inner) side to the lower (outer) side.

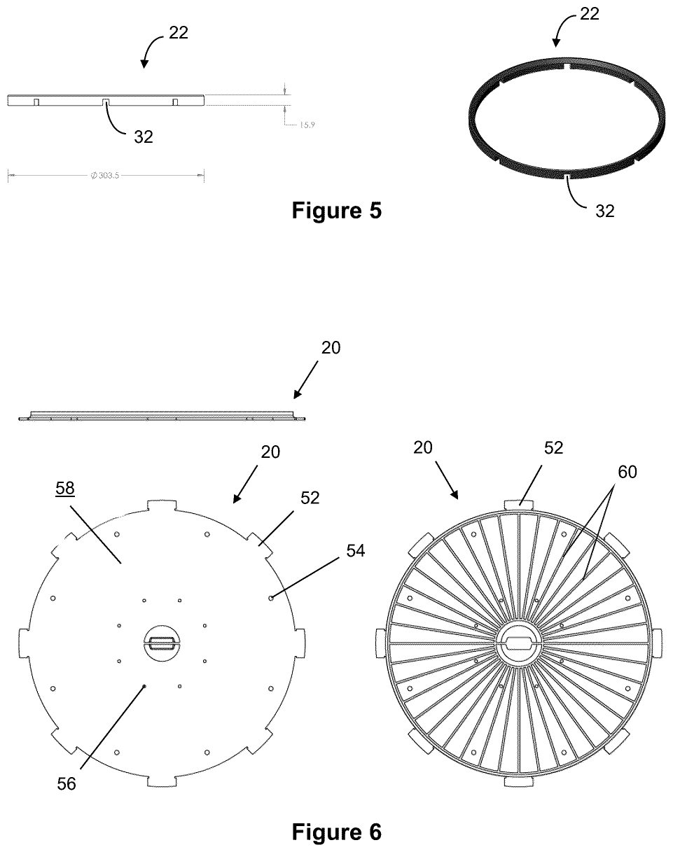

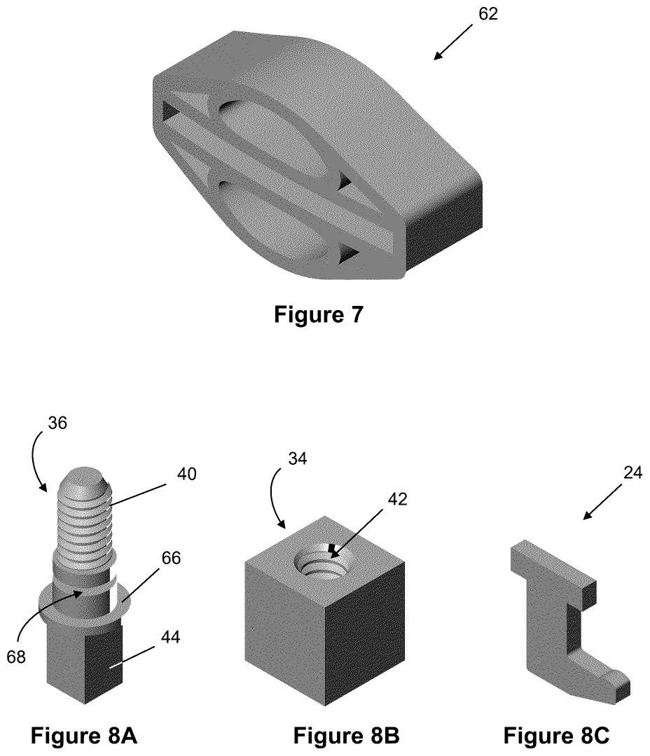

With reference to FIG. 6, the percussion pad assembly 10 also includes a bottom plate 20. As depicted, the bottom plate 20 has a substantially circular shape with a plurality of radially outwardly extending fingers 52 circumferentially spaced about the outer periphery. Each of the fingers 52 may be sized, shaped and positioned to receive a shock absorber 62 (FIG. 7) and then fit axially through one of the notches 50 in the bottom hoop 14 with the interior circular portion of the plate radially within the bottom hoop 14. The plate 20 may additionally define one or more holes, such as the depicted outer holes 54 and inner holes 56, and may have numerous radially extending ribs 60 on its lower side.

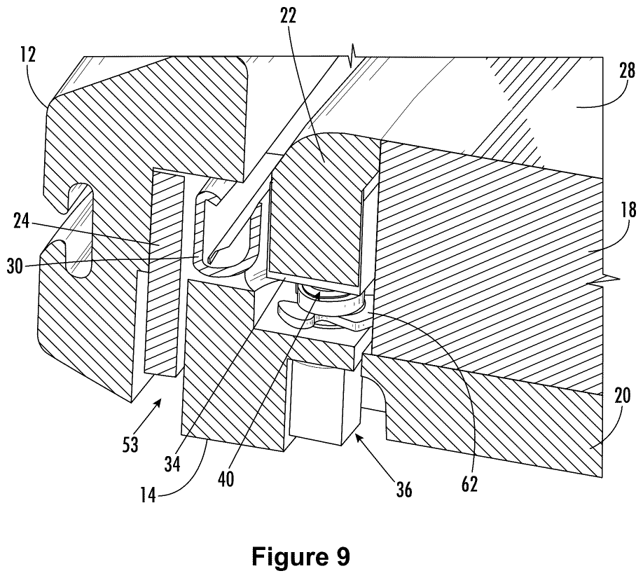

FIGS. 8A-8C respectively show preferred embodiments of a tension rod 36, nut 34 and connector 24. As shown, the tension rod 36 includes an upper threaded portion 40 and a lower polygonal portion 44 with an annular shelf 66 and inward slot 68 axially therebetween. The nut 34 has a polygonal shape and a central threaded bore 42. In the depicted embodiments, the lower portion 44 of the tension rod and the nut 34 are rectangular, however, this particular contour is non-limiting. In this embodiment, the connectors 24 are each formed as a J-clip, and may be configured to be molded into or otherwise rigidly attached to the top hoop 12. In the depicted preferred embodiment, the connectors 24 serve as locking fingers between the top hoop and bottom hoop. Notably, the exact form of the connectors 24 is non-limiting, as other shapes or even integrally molded locking fingers and/or nuts are contemplated within the scope of the disclosed invention. Most generally, the connectors 24 are configured to provide a strong and optionally releasable connection between the top hoop 12 and bottom hoop 14.

Assembly of the percussion pad assembly 10 is best understood with reference to FIGS. 1 and 9. The top hoop 12 and bottom hoop 14 cooperatively serve as the radially outer and axially outer shells of the percussion pad assembly 10 to hold the device together. The drumhead 16 fits within the top hoop 12 with the rim 30 abutting a lower surface or shelf in the top hoop to maintain the drumhead 16 axially within the pad 10. When assembled, the membrane 28 extends across the open inner area of the top hoop 12 and is tightened down onto the upper edge of the bearing ring 22, and is exposed to a user.

The bottom hoop 14 and bearing ring 22 typically remain connected to one another via threaded engagement between each tension rod 36 and a corresponding threaded bore 42 of each nut 34. As shown in FIG. 9, in the depicted preferred embodiment, the nut 34 may be molded into or otherwise rotationally fixed relative to the bearing ring 22. The tension rod 36 is axially fixed and rotationally independent to the bottom hoop 14. In the depicted embodiment, each tension rod 36 is maintained in this position via a clip 62 received within the slot 68. The nut 34 is rotationally fixed to the bearing ring 22 such that rotation of the tension rod 36 causes the nut 34 to move axially along the threaded portion of the rod to raise or lower the bearing ring. The top hoop 12 and bottom hoop 14 are attached to one another with each J-clip style connector 24 of the top hoop inserted through a slot 53 in the bottom hoop, and rotating into engagement with the peripheral platform 46 to axially lock the top hoop to the bottom hoop. Other embodiments of optionally releasable locking mechanisms are contemplated, including snapping elements, clips, hooks, pivoting members, and releasable levers, for example. When assembled in this manner, the bearing 22 fits radially inward of the rim 30 against the bottom surface of the membrane 28, as seen clearly in the view of FIG. 9.

With the top hoop 14 and bottom hoop 12 engaged with one another, the resilient pad 18 may be inserted axially within the central opening of the bottom hoop 14 and secured in place from below by the plate 20. The plate 20 is attached to the assembly via axial insertion through the central opening of the bottom hoop 14 with each of the fingers 52 (with resilient shock absorbers 62, if present) passing through a corresponding notch 50, followed by rotation of the plate 20 such that each finger travels over a ramp 48 and into a vertical recess 49 defined within the corresponding ramp element 47, thus axially locked in a quasi-bayonet fitting. The bottom surface of the plate 20 may include ribs 60 extending radially from an inner section toward the outer section to improve grip for a user for twisting the plate into place and to add rigidity, as in the depicted embodiment. When the plate 20 is attached in this manner, it cooperates with the membrane 28 to sandwich the resilient pad 18 in an inner section of the percussion pad assembly 10. The plate 20 may also include outer holes 54 and inner holes 56 for optionally mounting add-on elements, such as a sensor for converting the percussion pad assembly 10 into an electronic drum.

The above described percussion pad assembly provides for adjustment of the tension of the beatable membrane 28 via the tension rods 36 that are accessible from underneath the bottom hoop 14 with a standard drum key (or comparable torquing wrench). Rotation of the rods in a first tightening direction causes the bearing 22 to rise and increase tension of the membrane, and rotation in the opposite loosening direction causes the bearing to lower and reduce tension. When assembled, the resilient shock absorbers 62 provide a tight engagement with the bottom hoop 14 and prevent the plate from rattling against other hard elements. Additionally, as assembled, the resilient pad 18 is easily accessible without disassembling the entire percussion pad assembly 10 simply by rotating the plate 20 to disengage each of the fingers 52 from a corresponding ramp element 47 into alignment with a corresponding notch 50, and then removing the plate through the central opening in the bottom hoop 14. In this manner, a user can replace a worn out resilient pad with a new pad and/or an existing resilient pad with one that has different hardness and/or acoustic properties. A preferred embodiment of the depicted resilient pad 18 is formed from a compressive foam material, but other substrates with different properties, including non-foam materials, may optionally be employed. As a non-limiting example, an insert configured to mimic the sound of a snare may used. Additionally, embodiments exist that utilize multiple resilient pads, foam and/or non-foam, within the assembly for different sounds and feel.

In a preferred embodiment, the hoops 12 and 14, bearing ring 22 and plate 20 are formed from a molded plastic material; the drumhead rim 30, tension rods 36, nuts 34, connectors 24 and retaining ring 62 are formed from metal (steel, for example); the membrane is formed from a porous mesh material (KEVLAR® brand or related aramid synthetic fibers or PEEK, for example); the resilient pad 18 is formed from a porous foam (polyurethane, for example), and the shock absorbers 62 are also formed from a resilient material (silicone, for example). These specific materials are exemplary and non-limiting, as are the specific shapes and sizes of the depicted elements.

While not depicted in the Figures, in another embodiment, the bottom plate 20 is vertically adjustable while attached to provide an additional means of adjusting pressure or tension. The vertical adjustability can be made possible with a series of stepwise ramp sections in the bottom hoop.

Also not depicted is an alternate embodiment that includes a standard “acoustic” drumhead made from a polymer film (Mylar®, polyester, aramid or similar). A user can replace the depicted drumhead 16 with mesh membrane 28 with the acoustic drumhead to effectively convert the percussion pad assembly 10 from a practice pad into an acoustic drum. In this embodiment, the inner resilient pad(s) 18 and optionally the bottom plate 20 would typically be removed to form the acoustic drum. The acoustic drumhead is operable within the percussion pad assembly 10 as described above with respect to the mesh drumhead 18, by adjusting the height of the bearing ring 22 by torquing the tension rods 36 from underneath.

The disclosed embodiments provide a significantly improved percussion pad assembly that is tension adjustable, able to be disassembled without tools, allows replacement or removal of the inner resilient pad and which provides an improved feel when used as a practice pad. Further, the percussion pad assembly can be converted easily from a practice pad into an acoustic drum, as described above. Hardware such as brackets may be included to mount the drumhead assembly 10 to a stand, which may also be part of a kit of multiple drumhead assemblies. The holes in the bottom plate may optionally be used to attach hardware.

Additionally, as those skilled in the art readily understand, the inventive concepts are not limited in terms of specific dimensions. Various dimensions of the percussion pad assembly exist, which is especially useful in forming a drum kit with multiple different drums (tom and snare, for example).

While a preferred embodiment has been set forth for purposes of illustration, the foregoing description should not be deemed a limitation of the invention herein. Accordingly, various modifications, adaptations and alternatives may occur to one skilled in the art without departing from the spirit of the invention and scope of the claimed coverage.

What is claimed is:

1. A percussion assembly, comprising:
a top membrane defining a beating surface;
a lower member spaced from the top membrane; and
a resilient pad sandwiched between the top membrane and the lower member, wherein
the lower member is disengageable to allow access to the resilient pad.

2. The percussion assembly of claim 1, wherein the membrane and the lower member are maintained in place via an outer frame about the outer periphery.

3. The percussion assembly of claim 2, wherein the outer frame includes a top hoop frame member and a bottom frame member that are attached to one another to maintain the membrane and lower member in place when assembled.

4. The percussion assembly of claim 1, wherein the lower member is a substantially flat plate.

5. The percussion assembly of claim 1, wherein a tension level of the membrane is adjustable.

6. The percussion assembly of claim 5, further comprising one or more tension rods with an exposed end, wherein the tension level of the membrane is adjustable via torquing the one or more tension rods.

7. The percussion assembly of claim 6, wherein the exposed end of the one or more tension rods is accessible from a position below the membrane.

8. The percussion assembly of claim 7, wherein the membrane and the lower member are maintained in place via an outer frame about the outer periphery, and the one or more tension rods are engaged with the frame with a portion thereof extending through a hole in the outer frame in a rotationally independent engagement.

9. The percussion assembly of claim 6, further comprising a bearing member positioned underneath the membrane, wherein torquing the one or more tension rods causes movement of the bearing member toward the membrane to increase tension or away from the membrane to decrease tension.

10. The percussion assembly of claim 1, further comprising
an outer frame about the periphery of the membrane and lower member to maintain the membrane and lower member in place;
a bearing ring positioned axially between the lower member and the membrane; and
one or more tension rods in communication with the bearing ring and accessible from the outer frame, wherein
torquing the one or more tension rods in a first direction causes the bearing ring to move toward the membrane to increase tension and torquing the one or more tension rods in a second direction causes the bearing ring to move away from the membrane to decrease tension.

11. The percussion assembly of claim 1, wherein the membrane comprises a porous mesh material.

12. A percussion assembly, comprising:
a drumhead membrane with a beating surface;
an outer drumhead frame member with an inner edge defining an open radially inner area through which the beating surface of the drumhead membrane is exposed, the outer drumhead frame member having an upper portion and a lower portion;
a bearing member between the top membrane and lower portion of the drumhead frame member;
one or more tension rods extending through the lower portion of the drumhead frame member rotatably independent thereof and in communication with the bearing member, wherein
rotating the one or more tension rods in a first direction causes the bearing ring to move toward the membrane to increase tension and rotating the one or more tension rods in a second direction causes the bearing ring to move away from the membrane to decrease tension.

13. The drum of claim 12, wherein
the membrane further comprises a bottom surface opposite the beating surface,
the drumhead membrane is secured about its outer edge by a structural frame element,
the structural frame element is positioned axially between the upper portion and inner portion, and
the bearing member is positioned radially inward of the structural frame element against the lower surface of the membrane.

14. The percussion assembly of claim 12, wherein the upper portion and the lower portion of the outer drumhead frame member are detachable from one another to release the drumhead membrane and bearing element.

15. The percussion assembly of claim 12, further comprising a resilient pad positioned within the outer drumhead frame member against the membrane.

16. The percussion assembly of claim 15, further comprising a lower plate element that sandwiches the resilient pad with the membrane, wherein the lower plate element is detachable from the outer drumhead frame member to allow access to the resilient pad.

17. A percussion assembly, comprising:
a top hoop-shaped frame member defining an open inner area;
a bottom frame member releasably attached to the top hoop;
a drumhead comprising a membrane stretched across an annular ring, wherein
the annular ring is trapped between an inner surface of the top hoop-shaped frame member and an inner surface of the bottom frame member with the membrane exposed from the open inner area, and
the top hoop-shaped frame member and bottom frame member are disengageable from one another without use of tooling to thereby release the drumhead.

18. The percussion assembly of claim 17, wherein the bottom frame member is hoop-shaped defining a second open inner area.

19. The percussion assembly of claim 18, further comprising a bottom plate attachable to the bottom frame member to close at least a portion of the second open inner area.

20. The percussion assembly of claim 19, further comprising a resilient pad positioned between the membrane and bottom plate, wherein
the bottom plate is disengageable from the bottom frame member without use of tooling to allow access to and optional removal of the resilient pad.
